(19) United States
(12) Patent Application Publication
(10) Pub. No.: US 2014/0005294 A1
(43) Pub. Date: Jan. 2, 2014

(54) WATER BASED SILICONE COATING COMPOSITIONS

(71) Applicants: Marc E. Gage, Feeding Hills, MA (US); David J. Grulke, Tolland, CT (US); Blair A. Smith, South Windsor, CT (US)

(72) Inventors: Marc E. Gage, Feeding Hills, MA (US); David J. Grulke, Tolland, CT (US); Blair A. Smith, South Windsor, CT (US)

(73) Assignee: HAMILTON SUNDSTRAND CORPORATION, Windsor Locks, CT (US)

(21) Appl. No.: 13/536,067

(22) Filed: Jun. 28, 2012

(51) Int. Cl. C09D 5/14

(52) U.S. Cl. 523/122

(57) ABSTRACT

A water-based silicone coating composition comprises (a) about 39.6 wt % to about 67.3 wt % of a silicone resin emulsion; (b) about 8.3 wt % to about 19.2 wt % of a non-water reactive leafing filler material having a laminar structure; (c) about 0.05 wt % to about 3.0 wt % of a water soluble nonionic surfactant; (d) about 0.05 wt % to about 0.15 wt % of a minimally toxic biocide solution including at least one active biocide component effective against anaerobic sulfur-reducing bacteria; and (e) about 10.35 wt % to about 52.0 wt % of water. The sum of components a, b, c, d, and e total 100 wt % of the coating composition.

### BACKGROUND

The described subject matter relates generally to coatings for aluminum substrates, and more specifically to aluminum silicone based coatings, and methods for making such coatings.

Aluminum silicone coating compositions have low viscosity during application and broad corrosion resistance after curing. This makes these coating compositions suitable for many different applications. Certain coatings have been adapted for use in protectively coating internal fins and passages of high temperature aluminum heat exchangers. The low viscosity improves flowability of the coating composition around and through extremely narrow tubes indicative of air-to-air heat exchangers.

### SUMMARY

A water-based silicone coating composition comprises (a) about 39.6 wt % to about 67.3 wt % of a silicone resin emulsion; (b) about 8.3 wt % to about 19.2 wt % of a non-water reactive leafing filler material having a laminar structure; (c) about 0.05 wt % to about 3.0 wt % of a water soluble nonionic surfactant; (d) about 0.05 wt % to about 0.15 wt % of a minimally toxic biocide solution including at least one active biocide component effective against anaerobic sulfur-reducing bacteria; and (e) about 10.35 wt % to about 52.0 wt % of water. The sum of components a, b, c, d, and e total 100 wt % of the composition.

A method for producing a water-based silicone coating composition comprises blending water and a water soluble nonionic surfactant, and allowing the surfactant to dissolve to form a water solution. A non-water reactive leafing filler material having a laminar structure is added to the water solution and allowed to fully disperse to form a dispersion. A silicone resin emulsion is blended with water and allowed to fully dissolve into a diluted emulsion. Between about 0.05 wt % to about 0.15 wt % of a compatible, minimally toxic biocide solution is added to the diluted emulsion, the biocide solution including at least one active biocide component effective against anaerobic sulfur-reducing bacteria. The biocide solution is allowed to fully dissolve into the diluted emulsion. The dispersion is added to the dissolved diluted emulsion to form an admixture and allowed to fully disperse.

### DETAILED DESCRIPTION

One type of coating composition is a silicone-based emulsion containing generally a silicone resin solution, an aluminum leafing pigment, and water. Application and curing of the composition on a substrate results in a coating with aluminum suspended in a siloxane matrix. Specific examples of compositions, methods, and coating applications are described in commonly assigned U.S. Pat. Nos. 5,421,865 and 5,477,918, both incorporated herein by reference in their entirety.

Production variations, normal plant shutdowns, changing customer demands, etc., can result in raw materials sometimes being stored for longer than expected times. In industrial facilities, it has been found that the shelf life of some siloxane-based coating admixtures is limited to about two months. In storage, the admixture separates over time into a silicone resin emulsion film on top of the aqueous solution. After this separation, a number of these silicone admixtures have been found to harbor strains of anaerobic, sulfur-reducing bacteria. Unimpeded growth of this bacteria reduces the quality of the coating and complicates the application and curing process. Thus when production is slowed or stopped for a substantial period of time, the coating composition often ends up going to waste, with attendant disposal costs and environmental concerns. The composition could be stored elsewhere to inhibit bacterial growth, but such an undertaking is expensive, and impractical in large facilities to keep significant quantities at reduced temperatures. Even in such cases, the bacteria would not be killed, but rather reduced to spores that would reactivate when returned to room temperature. Elevated temperatures would also kill most bacteria, but it would prematurely cure the composition before application to a substrate.

Biocide solutions are sometimes added to latex paints in order to inhibit microbial growth and extend storage periods. However, not all biocide solutions suitable or recommended for latex emulsions are necessarily compatible with siloxane based emulsions. As detailed in the incorporated references, the described siloxane-based compositions have very low viscosities to enable emulsion flow around and through narrow passages typically designed for vapor phase flow like those in air-to-air heat exchangers.

Thus there is a need for compatible biocides for wet-state protection of siloxane-based coating emulsions that will not affect the overall composition, nor one that will unduly affect application of the emulsion or quality of the cured coating. Neither the active biocide component(s) nor its solvent should be reactive with any of the constituents of the coating composition, including silicone and aluminum. The biocide solution should also not inhibit the bonding of the silicone resin molecules into a siloxane matrix. To minimize reactivity and maintain a favorable environment for formation of the matrix, the biocide solution should not be acidic, but rather a mild to moderate base. In certain embodiments, the biocide solution is normalized to a pH value between about 9.0 and about 12.0 prior to introduction into the coating composition. Certain biocide solutions are manufactured as a mild to moderate base solution, while others may require minor pH adjustments to lower reactivity with the other coating constituents and/or to minimize pH effects of the biocide solution on the curing process.

To maintain quality of the final coating comparable to previous coating compositions, the solvent of the biocide solution should evaporate, decompose, or become incorporated into the coating during curing. The active biocide component(s) should additionally be effective in very small concentrations as seen in the examples below. These low concentrations also can further mitigate any health and safety considerations encountered during making or storing or application of the coating composition.

Three classes of active biocide components were identified as having the desired combination of biological activity and compatibility with silicone and aluminum constituents of the siloxane-based coating composition.

One class of active biocide components is the class of hexahydrotriazines, which contain a hydroxyalkyl (CₓH_{y}(OH)_{z}) chain bonded to at least one of the carbon atoms of a heterocyclic triazine (C₃N₃) ring. In this case, x≧1, z≧1, and y≧((2*x)−(z−1)). In certain embodiments, the hydroxyalkyl chain is a hydroxyethyl (C₂H₄OH) chain. In certain related embodiments, the triazine ring contains a hydroxyalkyl chain bonded to all three of the carbon atoms on the triazine ring. In certain of those embodiments, all three hydroxyalkyl chains are hydroxyethyl chains. One example of such a biocide component is identified as hexahydro-1,3,5-tris(2-hydroxyethyl)-s-triazine. This active biocide component is available commercially as an aqueous solution under the trade designation Triadine® 174, from Arch Chemicals, Inc. of Atlanta, Ga. In a 10% solution (1 part Triadine® 174 to 9 parts water), the pH ranges between about 10.0 and about 11.5, making it suitable for inclusion in the coating composition without affecting the other constituents or impeding the curing process. Triadine® 174 is rated as having lower toxicity, lower flammability, and decreased physical hazards, as compared to other baseline hexahydrotriazine components containing no hydroxyl groups on any of the alkane chains bonded to the triazine ring.

Another class of potential active biocide components is the class of benzisothiazoles, which contain a thiazole (C₃NS) ring where two of its carbon atoms are shared with two atoms of a cyclohexane (C₆) ring. An example benzisothiazole molecule that has been found compatible and minimally reactive with aqueous siloxane emulsions is benzisothiazolin-3-one. This example component has an oxygen atom double bonded to the third carbon atom on the thiazole ring that is not shared with the cyclohexane ring. Benzisothiazolin-3-one is commercially available from Arch Chemicals, Inc. of Atlanta, Ga. in a dipropylene glycol solution sold under the trade designation Proxel® GXL. In a 10% solution (1 part Proxel® GXL to 9 parts water), the pH is about 12.0, making it suitable for inclusion in the coating composition without affecting the other constituents or impeding the curing process. This example active component, in combination with a glycol-based solvent, is soluble in the aqueous siloxane based emulsion while also being rated with lower toxicity, lower flammability, and decreased physical hazards, as compared to the baseline biocide solution as shown below.

A third class of potential active biocide components includes one or more partially-brominated alkanes. While some brominated compounds have been outlawed or removed from commercial channels due to potential for negative environmental effects, a subclass of partially brominated alkanes are available which retain suitable inhibition of microbial growth while also having acceptable environmental, health, and safety ratings. Two example active components from this class includes 1,2-dibromo-2,4-dicyanobutane, and 2-bromo-2-nitro-1,3-propanediol. The 2-bromo-2-nitro-1,3-propanediol molecule has a nonproprietary pharmaceutical name of bronopol. A combination of these two active components in a dipropylene glycol solution is available commercially from Lanxess Corporation of Pittsburgh, Pennsylvania and sold under the trade designation Biochek® 721M. In a 1% aqueous solution (1 part Proxel® GXL to 99 parts water), the pH is about 5.0. However, the pH of the 1% Proxel® GXL solution can be readily normalized by any conventional means such as by addition of a hydroxide base for making the biocide solution more suitable for inclusion in the coating composition without affecting the other constituents or impeding the curing process.

Table 1 below compares objective and subjective measurements of health and safety factors for the three example biocide solutions as compared to a conventional alkyl triazine-based biocide component like hexahydro-1,3,5-triethyl-s-triazine (sold commercially as Vancide® TH by R. T. Vanderbilt Company, Inc. of Norwalk, Conn.). These values have been summarized from product information sheets and material safety data sheets provided by the respective manufacturers and/or vendors named above. The numeric Health, Flammability, and Physical Hazard ratings are standardized hazardous material information system (HMIS) ratings using criteria from Occupational Safety and Health Administration regulations and/or National Fire Protection Association (NFPA) ratings. On each scale, 0 is the least dangerous and 4 is the most dangerous. LD50 is the median lethal dose according to the method of exposure.

TABLE 1
Comparison of Example Biocide Solutions for Siloxane-Based Emulsions

| | Biocide Solution | | | |
|---|---|---|---|---|
| Trade | VANCIDE ® TH | | | |
| Designation | (Baseline) | TRIADINE ® 174 | PROXEL ® GXL | BIOCHEK ® 721 |
| Active | hexahydro-1,3,5- | hexahydro-1,3,5- | 1,2-benzisothiazolin- | 1,2-dibromo-2,4- |
| Component(s) | triethyl-s-triazine | tris(2-hydroxyethyl)- | 3-one | dicyanobutane |
| | | s-triazine | | 2-bromo-2-nitro- |
| | | | | 1,3-propanediol |
| HMIS Rating - | 4 | 2 | 3 | 3 |
| Health | | | | |
| HMIS Rating - | 2 | 0 | 0 | 1 |
| Flammability | | | | |
| HMIS Rating - | 1 | 0 | 0 | 0 |
| Physical Hazards | | | | |
| LD50 Oral | 280 mg/kg | 680 mg/kg | 1,221 mg/kg | 790 mg/kg |
| Toxicity (Rat) | | | | |
| LD50 Dermal | 499 mg/kg | >2,000 mg/kg | >2,000 mg/kg | >2,000 mg/kg |
| Toxicity (Rabbit) - | | | | |
| mg/kg | | | | |
| Flashpoint, ° F. | 151 | Not Combustible | Not Combustible | >200 |

Table 1 shows that Vancide® TH will most likely require substantial handling and storage precautions, which can slow down the production process and increase manufacturing costs. Table 1 shows the three examples of minimally toxic biocide solutions taken from the classes described above, each having lower toxicity, flammability, and other hazardous characteristics as compared to tri-alkyl triazine components like those found in Vancide® TH.

Further, in the case of Triadine® 174, it can be seen that the health rating is reduced, and flammability risk is virtually eliminated despite its relative chemical similarity to Vancide® TH. Toxic oral and dermal concentrations of Triadine® 174 are more than double that of Vancide® TH. This is achieved with an added hydroxyl (—OH) functional group on the three peripheral ethyl chains, greatly reducing the deleterious effects of the biocide solution while still maintaining its useful biological effects on anaerobic sulfur-reducing bacteria. It would have been expected that the hydroxyl groups would increase reactivity with the silicone resin or the aluminum leafing pigment, or would otherwise inhibit the curing reaction, but instead, this active biocide component, in suitable concentrations, remains inert to the coating emulsion and the aluminum siloxane coating.

As noted above, one or more minimally toxic biocide solutions can be added to a siloxane based coating composition. For example, the aluminum silicone compositions described in the incorporated references can additionally include between about 0.05 wt % and about 0.15 wt % of a minimally toxic biocide solution. In certain of those embodiments, there is between about 0.06 wt % and about 0.10 wt % of the minimally toxic biocide solution in the coating composition. The minimally toxic biocide solution can take the place of a like amount of water.

Thus in certain embodiments, a silicone coating composition can include (a) about 39.6 wt % to about 67.3 wt % of a silicone resin emulsion; (b) about 8.3 wt % to about 19.2 wt % of a non-water reactive leafing filler material having a laminar structure; (c) about 0.05 wt % to about 3.0 wt % of a water soluble nonionic surfactant; (d) about 0.05 wt % to about 0.15 wt % of the minimally toxic biocide solution including at least one active biocide component effective against anaerobic sulfur-reducing bacteria; and (e) about 10.35 wt % to about 52.0 wt % of water, with the sum of components a, b, c, d, and e totaling 100 wt % of the composition.

As noted above, at least one of the active biocide components can be selected from the group: 1,2-dibromo-2,4-dicyanobutane; 2-bromo-2-nitro-1,3-propanediol (also known as bronopol); 1,2-benzisothiazolin-3-one; hexahydro-1,3,5-tris(2-hydroxyethyl)-s triazine, and mixtures thereof. In certain of those embodiments, the minimally toxic biocide solution includes a mixture of at least two active biocide components: 1,2-dibromo-2,4-dicyanobutane and 2-bromo-2-nitro-1,3-propanediol. This mixture can optionally be a part of a minimally toxic biocide solution such as Biochek® 721M or its equivalents.

In certain others of those embodiments, the minimally toxic biocide solution includes 1,2-benzisothiazolin-3-one as an active biocide component. This active biocide component can be part of a minimally toxic biocide solution such as Proxel® GXL or its equivalents.

In yet certain others of those embodiments, the minimally toxic biocide solution includes hexahydro-1,3,5-tris(2-hydroxyethyl)-s triazine as an active biocide component. This active biocide component can be part of a minimally toxic biocide solution such as Triadine® 174 or its equivalents.

Generally speaking, the example resin may include (a) about 38 wt % to about 72 wt % phenylmethyl silicone resin; (b) about 0.01 wt % to about 1.0 wt % sodium lauryl sulfate; and (c) about 27 wt % to about 62 wt % by weight water, with the sum of components a, b and c totaling 100 wt %. One example silicone resin composition, sold commercially under the trade designation Silres® MP42E by Wacker Chemie A G of Munich, Germany, may include (a) about 40 wt % to about 44 wt % phenylmethyl silicone resin; (b) about 0.01 wt % to about 1.0 wt % sodium lauryl sulfate; and (c) about 55 wt % to about 60 wt % by weight water, with the sum of components a, b and c totaling 100 wt % of the silicone resin composition. An alternative example silicone resin composition, currently sold commercially under the trade designation Silres® MP50E by Wacker Chemie AG may include (a) about 48 wt % to about 52 wt % phenylmethyl silicone resin; (b) about 0.01 wt % to about 1.0 wt % sodium lauryl sulfate; and (c) about 47 wt % to about 52 wt % by weight water, with the sum of components a, b and c totaling 100 wt % of the silicone resin composition. The higher concentration of silicone resin in emulsions such as Silres® MP50E has been found to improve curing and appearance of the final coating with a minimum of blistering and other surface defects as compared to lower concentrations of silicone resin such as those found in Silres® MP42E, improving customer acceptance rates of finished products. However, both example silicone resin emulsion compositions, as well as other emulsion compositions falling within the above-described compositional ranges, are suitable for use with the described subject matter.

Suitable leafing filler materials generally comprise aluminum leafing pigment in a composition ranging between about 66 wt % to about 82 wt % of pigment, with the balance mineral spirits and other inactive ingredients. One example of a suitable leafing filler material may include about 66 wt % to about 70 wt % of aluminum leafing pigment dispersed in mineral spirits. An example of this pigment composition is currently sold commercially under the trade designation Aquapaste® 205-5 by Silberline Manufacturing Company of Tamaqua, Pa. A second example suitable leafing filler material may include about 78 wt % to about 82 wt % aluminum leafing pigment dispersed in mineral spirits. An example of this composition is sold commercially under the trade designation Aquasilber® LPW 2150, also by Silberline Manufacturing Company. Other leafing fillers with compositions falling in the above example pigment concentrations are also suitable for use with the described subject matter.

Consistent with the examples below, the coating composition can therefore comprise about 45.0 wt % to about 60.0 wt % of a silicone resin emulsion. The silicone resin emulsion may include (i) about 40 wt % to about 52 wt % phenylmethyl silicone resin; (ii) about 0.01 wt % to about 1.0 wt % sodium lauryl sulfate; and (iii) about 47 wt % to about 59 wt % water with the sum of components i, ii and iii totaling 100 wt % of the silicone resin emulsion. The coating composition can also include about 10.0 wt % to about 16.2 wt % of a non-water reactive leafing filler material having a laminar structure. In certain embodiments, such as in the examples shown below, the coating composition includes, within tolerance limits, between about 10.5 wt % and about 14.0 wt % of the leafing filler material. Though the wider range is acceptable for many coating applications, this narrower range is tailored to balance the aluminum suspended in the siloxane matrix after curing to provide more uniform and robustly coated surfaces for many narrow passaged air-to-air heat exchangers. The aluminum leafing filler material can include aluminum leafing pigment dispersed in mineral spirits. A surfactant such as a water soluble nonionic acetylenic glycol solution can optionally be included to improve wettability of the diluted emulsion. In certain embodiments, the surfactant concentration, within tolerance limits, is between about 0.3 wt % and about 0.7 wt %. The coating composition can also include about 0.05 wt % to about 0.15 wt % of a compatible, minimally toxic biocide solution including at least one active biocide component effective against anaerobic sulfur-reducing bacteria. The active biocide component(s) can be selected from the group consisting of: 1,2-dibromo-2,4-dicyanobutane; 2-bromo-2-nitro-1,3-propanediol; 1,2-benzisothiazolin-3-one; and hexahydro-1,3,5-tris(2-hydroxy-ethyl)-s triazine, and mixtures thereof. The remainder of the solution can be from about 23.0 wt % to about 44.6 wt % water, with the sum of the silicone resin emulsion, the leafing filler material, the optional surfactant, the minimally toxic biocide solution, and the water totaling 100 wt % of the coating composition.

### EXAMPLES

Following are several example compositions for a siloxane based coating composition having an extended shelf life. As described below, the coating composition is formed in two parts into an aqueous dispersion and a resin emulsion, then combined into an admixture to form the final emulsion.

### Example 1

| | Wt % |
|---|---|
| Dispersion | |
| Deionized Water | 11.32 |
| Surfynol ® 465 | 0.6 |
| Aquapaste ® 205-5 | 11.3 |
| Emulsion | |
| Silres ® MP50E | 49.7 |
| Deionized Water | 27 |
| Triadine ® 174 | 0.08 |

### Example 2

| | Wt % |
|---|---|
| Dispersion | |
| Deionized Water | 13.12 |
| Surfynol ® 465 | 0.6 |
| Aquapaste ® 205-5 | 13.1 |
| Emulsion | |
| Silres ® MP50E | 49.7 |
| Deionized Water | 23.4 |
| Triadine ® 174 | 0.08 |

### Example 3

| | Wt % |
|---|---|
| Dispersion | |
| Deionized Water | 11.32 |
| Surfynol ® 465 | 0.6 |
| Aquapaste ® 205-5 | 11.3 |
| Emulsion | |
| Silres ® MP50E | 49.7 |
| Deionized Water | 27 |
| Proxel ® GXL | 0.08 |

### Example 4

| | Wt % |
|---|---|
| Dispersion | |
| Deionized Water | 11.32 |
| Surfynol ® 465 | 0.6 |
| Aquapaste ® 205-5 | 11.3 |
| Emulsion | |
| Silres ® MP50E | 49.7 |
| Deionized Water | 27 |
| Biochek@ 721M | 0.08 |

### Example 5

| | Wt % |
|---|---|
| Dispersion | |
| Deionized Water | 11.32 |
| Surfynol 465 | 0.6 |
| Aquasilber ® LPW 2150 | 11.3 |
| Emulsion | |
| Silres ® MP50E | 49.7 |
| Deionized Water | 27 |
| Triadine ® 174 | 0.08 |

### Example 6

| | Wt % |
|---|---|
| Dispersion | |
| Deionized Water | 11.32 |
| Surfynol ® 465 | 0.6 |
| Aquapaste ® 205-5 | 11.3 |
| Emulsion | |
| Silres ® MP42E | 59.2 |
| Deionized Water | 17.5 |
| Triadine ® 174 | 0.08 |

### Example 7

| | Wt % |
|---|---|
| Dispersion | |
| Deionized Water | 11.92 |
| Surfynol ® 465 | 0 |
| Aquasilber ® LPW 2150 | 11.3 |
| Emulsion | |
| Silres ® MP50E | 49.7 |
| Deionized Water | 27 |
| Triadine ® 174 | 0.08 |

These and other similar coating compositions can be made according to the following method. First, water (such as deionized water) is optionally blended with a water soluble nonionic surfactant and allowed to dissolve to form a water solution. A non-water reactive leafing filler material having a laminar structure can be added to the water solution, and allowed to fully disperse, forming a dispersion. A silicone resin emulsion and water are blended to form a separate diluted emulsion and allowing the diluted emulsion to fully dissolve. About 0.05 wt % to about 0.15 wt % of a compatible, minimally toxic biocide solution is added to the diluted emulsion. The biocide solution includes at least one active biocide component effective against anaerobic sulfur-reducing bacteria. The biocide solution is allowed to fully dissolve into the diluted emulsion. The dispersion of water, leafing filler material, and optional surfactant are mixed with the diluted emulsion to form an admixture and allowed to fully disperse.

As noted above, the minimally toxic biocide solution is compatible with the other constituents of the composition, and may include one or more of the example active biocide components described herein. The silicone resin emulsion and filler material may be selected from one of the examples described above, or more generally can fall within the described compositional ranges. Certain minimally toxic biocide solutions may be normalized to a pH between about 9.0 and about 12.0 prior to being added to the diluted emulsion.

Once the coating composition is made, in most cases, it can be stored in ordinary industrial conditions for six to twelve months before use. Prior compositions without a compatible biocide can begin to foul after as little as two months. As noted above, the above coating compositions can then be applied to a substrate and cured to form an aluminum containing siloxane coating. The composition is useful for coating very thin aluminum passages such as but not limited to those found in heat exchangers.

To improve efficiency of the heat exchanger, including air-to-air heat exchangers used in aircraft thermal management or cabin air systems, the composition has an extremely low viscosity to flow in and through these passages. The composition viscosity can be measured by residence time in a No. 1 Zahn cup at around room temperature (about 75° F. / 23° C.). In certain embodiments, the residence time is between about 30-36 seconds, or between about 7.5 cP and about 15 cP.

The example coating compositions can be cured for heat exchanger applications by use of any of the following example combinations of time and temperature (time tolerance, ±10 minutes; temperature tolerance ±25° F.):

Curing Example 1: 45 minutes at about 300° F. (about 150° C.), then 60 minutes at about 350° F. (about 180° C.), then 90 minutes at about 550° F. (about 290° C.).

Curing Example 2: 45 minutes at about 300° F. (about 150° C.), then 36 hours at about 375° F. (about 190° C.), then 4 hours at about 450° F. (about 230° C.).

Curing Example 3: 45 minutes at about 300 ° F. (about 150° C.), then 60 minutes at about 350° F. (about 180° C.), then 90 minutes at 25° F. (about 15° C.) above service temperature.

Curing Example 4: 120 minutes at about 450° F. (about 230° C.).

While the above curing procedures are provided as examples, it will be appreciated that the exact times, temperatures, and order of steps, will vary to some degree based on the exact composition and the desired final coating properties.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A water-based silicone coating composition comprising:
a. about 39.6 wt % to about 67.3 wt % of a silicone resin emulsion;
b. about 8.3 wt % to about 19.2 wt % of a non-water reactive leafing filler material having a laminar structure;
c. about 0.05 wt % to about 3.0 wt % of a water soluble nonionic surfactant;
d. about 0.05 wt % to about 0.15 wt % of a minimally toxic biocide solution including at least one active biocide component effective against anaerobic sulfur-reducing bacteria; and
e. about 10.35 wt % to about 52.0 wt % of water;
wherein the sum of components a, b, c, d, and e total 100 wt %.

2. The composition of claim 1, wherein the at least one active biocide component is selected from a group consisting of: 1,2-dibromo-2,4-dicyanobutane; 2-bromo-2-nitro-1,3-propanediol;
1,2-benzisothiazolin-3-one; and hexahydro-1,3,5-tris(2-hydroxyethyl)-s triazine.

3. The composition of claim 2, wherein the at least one active biocide component comprises 1,2-dibromo-2,4-dicyanobutane and 2-bromo-2-nitro-1,3-propanediol.

4. The composition of claim 2, wherein the at least one active biocide component comprises 1, 2-benzisothiazolin-3-one.

5. The composition of claim 2, wherein the at least one active biocide component comprises hexahydro-1,3,5-tris(2-hydroxyethyl)-s triazine.

6. The composition of claim 1, wherein the silicone resin emulsion comprises:
a. about 38 wt % to about 72 wt % phenylmethyl silicone resin;
b. about 0.01 wt % to about 1.0 wt % sodium lauryl sulfate; and
c. about 27 wt % to about 62 wt % by weight water;
the sum of components a, b and c totaling 100 wt %.

7. The composition of claim 1, wherein the leafing filler material comprises about 66 wt % to about 82 wt % aluminum leafing pigment dispersed in mineral spirits.

8. The composition of claim 1, wherein the leafing filler material comprises about 78 wt % to about 82 wt % aluminum leafing pigment dispersed in mineral spirits.

9. The composition of claim 1, wherein the coating composition comprises between about 0.06 wt % and about 0.10 wt % of the minimally toxic biocide solution.

10. The composition of claim 1, which comprises:
a. about 45.0 wt % to about 60.0 wt % of a silicone resin emulsion comprising:
i. about 40 wt % to about 52 wt % phenylmethyl silicone resin;
ii. about 0.01 wt % to about 1.0 wt % sodium lauryl sulfate; and
iii. about 47 wt % to about 59 wt % water;
the sum of components i, ii and iii totaling 100 wt %;
b. about 10.0 wt % to about 16.2 wt % of a non-water reactive leafing filler material having a laminar structure, the filler material including aluminum leafing pigment dispersed in mineral spirits;
c. about 0.3 wt % to about 0.7 wt % water soluble nonionic acetylenic glycol; and
d. about 0.05 wt % to about 0.15 wt % of a compatible, minimally toxic biocide solution including at least one active biocide component effective against anaerobic sulfur-reducing bacteria, the at least one active biocide component selected from the group of: 1,2-dibromo-2,4-dicyanobutane; 2-bromo-2-nitro-1,3-propanediol; 1, 2-benzisothiazolin-3-one; and hexahydro-1,3,5-tris(2-hydroxyethyl)-s triazine; and
e. about 23.6 wt % to about 40.0 wt % water;
wherein the sum of components a, b, c, d, and e total 100 wt %.

11. A method for producing a water-based silicone coating composition, the method comprising:
blending water and a water soluble nonionic surfactant and allowing the surfactant to dissolve to form a water solution;
adding a non-water reactive leafing filler material having a laminar structure to the water solution and allowing the filler material to fully disperse to form a dispersion;
blending a silicone resin emulsion and water to form a diluted emulsion and allowing the diluted emulsion to fully dissolve;
adding between about 0.05 wt % to about 0.15 wt % of a compatible, minimally toxic biocide solution including at least one active biocide component effective against anaerobic sulfur-reducing bacteria, and
allowing the biocide solution to fully dissolve into the diluted emulsion; and
adding the dispersion to the dissolved diluted emulsion to form an admixture and allowing the admixture to fully disperse.

12. The method of claim 11, wherein the at least one active biocide component is selected from the group of: 1,2-dibromo-2,4-dicyanobutane; 2-bromo-2-nitro-1,3-propanediol; 1,2-benzisothiazolin-3-one; and hexahydro-1,3,5-tris(2-hydroxyethyl)-s triazine.

13. The method of claim 11, wherein the silicone resin emulsion comprises:
about 48 wt % to about 72 wt % phenylmethyl silicone resin;
about 0.01 wt % to about 1.0 wt % sodium lauryl sulfate; and
about 27 wt % to about 52 wt % water.

14. The method of claim 11, wherein the filler material comprises a pigment and a dispersant, the pigment having a laminar structure and selected from the group consisting of inhibited aluminum leafing pigment and leafing mica, the dispersant selected from the group consisting of mineral spirits, isopropanol and water.

15. The method of claim 11, wherein the coating composition comprises:
a. about 45.0 wt % to about 60.0 wt % of a silicone resin emulsion comprising:
i. about 40 wt % to about 52 wt % phenylmethyl silicone resin;
ii. about 0.01 wt %to about 1.0 wt % sodium lauryl sulfate; and
iii. about 47 wt % to about 59 wt % water;
the sum of components i, ii and iii totaling 100 wt % of the silicone resin emulsion;
b. about 10.0 wt % to about 16.2 wt % of a non-water reactive leafing filler material having a laminar structure, the filler material including aluminum leafing pigment dispersed in mineral spirits;
c. about 0.3 wt % to about 0.7 wt % water soluble nonionic acetylenic glycol; and
d. about 0.05 wt % to about 0.15 wt % of a compatible, minimally toxic biocide solution including at least one active biocide component effective against anaerobic sulfur-reducing bacteria, the at least one active biocide component selected from the group of: 1,2-dibromo-2,4-dicyanobutane, 2-bromo-2-nitro-1,3-propanediol, 1, 2-benzisothiazolin-3-one, and hexahydro-1,3,5-tris(2-hydroxyethyl)-s triazine; and
e. about 23.0 wt % to about 44.6 wt % water;
wherein the sum of components a, b, c, d, and e total 100 wt % of the coating composition.

16. The method of claim 15, wherein the at least one active biocide component comprises a combination of 1,2-dibromo-2,4-dicyanobutane and 2-bromo-2-nitro-1,3-propanediol.

17. The method of claim 15, wherein the at least one active biocide component comprises 1,2-benzisothiazolin-3-one.

18. The method of claim 15, wherein the at least one active biocide component comprises hexahydro-1,3,5-tris(2-hydroxyethyl)-s triazine.

19. The method of claim 11, wherein prior to step d, the minimally toxic biocide solution is normalized to a pH between about 9.0 and about 12.0.

20. A coating composition for forming a siloxane-based coating on a metal substrate, the composition containing a minimally toxic biocide solution that is chemically inert to the siloxane-based coating composition during storage, the biocide solution comprising an active biocide component effective against anaerobic, sulfur-fixing bacteria, and having a Hazard Management Information System (HMIS) health rating of less than 4 and a HMIS flammability rating of less than 2.
